(19) United States
(12) Patent Application Publication
(10) Pub. No.: US 2002/0124444 A1
(43) Pub. Date: Sep. 12, 2002

(54) Angled license plate holder

(76) Inventor: Ron Yaacov Davidson, Yaacov (IL)

Correspondence Address: HALE AND DORR LLP, 300 PARK AVENUE, NEW YORK, NY, 10022, US

(21) Appl. No.: 09/800,208

(22) Filed: Mar. 6, 2001

(51) Int. Cl. G09F 7/00

(52) U.S. Cl. 40/209

(57) ABSTRACT

A license plate holder for diffusing the flashlight of a vehicle-detection camera at different angles, comprising a fixed part connected to the vehicle and a movable part that may be positioned at different angles to the vehicle, by spacing them apart with differing lengths pins or at a fixed angle, by the fixed part having an angled shape, wherein the movable part holds a license plate and a license plate cover having a micro-prismatic lens.

### FIELD OF THE INVENTION

The present invention deals with license plate holders and particularly with means incorporated therein to provide angling of the license plate, so as to avoid detection by photo-radar, red-light camera and other photographic detection means for vehicles.

### BACKGROUND OF THE INVENTION

Traffic law-enforcement agencies all over the world use speed-detection devices such as laser and radar speed-guns, frequently coupled with a computer-controlled camera.

Radar speed-guns measure the speed of their target using the time-of-flight principle; they send out a train of signals and receive the return signals reflected off the moving vehicle. The time lapse between the radar signals going out and coming back is recorded and reveals the distance of the moving vehicle from the radar detector. Consecutive measurements over a period of time, typically 0.3 seconds, give the speed information.

In the event of excess speed detection, a computer-controlled camera is automatically operated, aimed at the vehicle's license plate, for identification of the speeding vehicle.

The vehicle-detection cameras used by the traffic police departments, such as the Montanova model F6, are operated at an angle of 22° to 22.5° when situated to the right of the moving vehicle and taking pictures of its back.

Various means are known for detecting and/or jamming radar signals, in order to avoid detection. The jamming devices, such as the Phantom Radar Jammer, manufactured by Galaxy Descramblers of Illinois, USA, receive the radar gun's signal and piggyback it with noise, so that the signal going back to the radar gun is not recognized by the computer.

Other existing means deal with obscuring the vehicle's license plate from the photo-radar camera. These products, such as the Protector, manufactured by On-Track Manufacturing Corp. of Blaine, Wash., use especially designed license plate covers, comprising a micro-prismatic lens, which bends light like a prism when viewed from a 35° angle. This effect makes the cover reflect the incoming light from the camera's flash, when impinging at 35°, horizontally or vertically, with an additional configuration that combines partial horizontal and vertical reflection. The cover looks transparent when viewed from directly behind (or in front of) the vehicle.

Another product, manufactured by Chimera of New Haven, Conn., provides a different type of micro-prismatic lens, designed to reflect incoming light starting at a predefined angle of 45° and covering the entire range from the starting angle to 180°.

There is clearly a need to compensate for the difference between the angle of photography and the maximum-coverage angle of the existing products.

U.S. Pat. Nos. 5,870,841 to Brody et al., 5,815,965 to de Greeve and 4,924,611 to Shaw, describe various license plate holders, designed to facilitate the removal of a license plate and to provide for advertisement or message space.

U.S. Pat. No. 4,956,930 to Troncoso describes a license plate cover provided with vanes, designed to obscure viewing of the plate identification from the side.

### SUMMARY OF THE INVENTION

The present invention provides a license plate holder, which is designed to perform several functions such as avoiding detection by photo-radar cameras, a red-light camera, or any other photographic detection means for vehicles. The license plate holder of the present invention additionally enables removal of the license plate when so desired.

In accordance with one aspect of the present invention a license plate holder is provided, comprising:

a back panel attached to the vehicle, said back panel comprising a plurality of angling drills;

a frame, attached to one axis of said back panel by a hinge; and

pins of differing lengths, adapted to be inserted into said plurality of angling drills.

In accordance with one embodiment, the frame comprises a base and a gripper, wherein said base may be open at its top or at one of its sides; and

pins of differing lengths, adapted to be inserted into said plurality of angling drills, wherein said base and said gripper comprise matching grooves.

In accordance with another embodiment, the frame comprises slits at its top and a flat panel, spanning said frame's length, said panel attached to two levers moving along vertical slits, said slits positioned on both side panels of said frame.

The frame may additionally comprise an advertisement space.

The present invention also provides, according to one aspect, a method for diffusing the flash light of a photo-radar camera at different angles, comprising the steps of:

providing a license plate holder having a fixed part and a movable part, wherein said fixed part may comprise an advertisement space and wherein said movable part is attached to said fixed part along one if said fixed part's sides and wherein said fixed is connected to the vehicle by a plurality of pins of differing lengths, forming an angle between said fixed part and the vehicle;

inserting a license plate into said movable part;

covering said license plate with a micro-prismatic lens cover by inserting said cover into said movable part; and

placing said pins so as to create a desired angle between said fixed part and the vehicle.

According to another aspect, the present invention provides a method for diffusing the flash light of a photo-radar camera at different angles, comprising the steps of:

providing a license plate holder having a fixed part and a movable part, wherein said movable part comprises a base and a gripper and wherein said movable part is attached to said fixed part along one if said fixed part's sides and wherein said fixed part is connected to the vehicle by a plurality of pins of differing lengths, forming an angle between said fixed part and the vehicle;

inserting a license plate into said movable part;

covering said license plate with a micro-prismatic lens cover by inserting said cover into said movable part.

According to yet another aspect, the present invention provides a method for diffusing the flash light of a photo-radar camera at different angles, comprising the steps of:

providing a license plate holder having a fixed part and a movable part, wherein said movable part comprises a base and a gripper and wherein said base comprises grooves, adapted to accommodate at least a license plate and a license plate cover and wherein said movable part is attached to said fixed part along one of said fixed part's sides and wherein said fixed part and the vehicle are connected by a plurality of pins of differing lengths, forming an angle between said fixed part and the vehicle;

inserting a license plate into said movable part;

covering said license plate with a micro-prismatic lens cover by inserting said cover into said movable part; and

According to yet another aspect, the present invention provides a method for diffusing the flash light of a photo-radar camera at different angles, comprising the steps of:

providing a license plate holder having a fixed part and a movable part, wherein said movable part comprises a base and a gripper and wherein said base comprises grooves, adapted to accommodate at least said license plate and said cover and wherein said gripper comprises grooves, said gripper grooves matching said base grooves, said gripper grooves adapted to grip at least said license plate and said cover and wherein said movable part is attached to said fixed part along one of said fixed part's sides and wherein said fixed part and the vehicle are connected by a plurality of pins of differing lengths, forming an angle between said fixed part and the vehicle;

inserting a license plate into said movable part;

covering said license plate with a micro-prismatic lens cover by inserting said cover into said movable part.

The movable part may also consist of one part, wherein said movable part comprises slits at its top and a flat panel, spanning said movable part's length, said panel attached to two levers moving along vertical slits, said slits positioned on both side panels of said movable part.

The present invention also provides a method for removing a license plate. In one embodiment the method comprises the steps of:

providing a license plate holder having a fixed part and a movable part, wherein said movable part is attached to said fixed part along one of its sides and wherein said movable part comprises a base and a gripper, said base comprising grooves adapted to accommodate at least one license plate and optionally a license plate cover, said gripper comprising matching grooves adapted to grip said at least one license plate and optionally said license plate cover;

pulling said at least one license plate and optionally said license plate cover out of said holder by removing said gripper; and

optionally covering said base with a second gripper, said second gripper having two possible configuration, namely with or without grooves.

In another embodiment the method comprises the steps of:

providing a license plate holder having a fixed part and a movable part, wherein said movable part is attached to said fixed part along one of its sides and wherein said movable part comprises slits at its top and a flat panel, spanning said frame's length, said panel attached to two levers moving along vertical slits, said slits positioned on both side panels of said frame; and

pulling said at least one license plate and optionally said license plate cover out of said holder by sliding said lever along said slits in an upward direction.

According to another aspect, the present invention provides a license plate holder comprising:

an angled back-panel attached to the vehicle; and

a frame, attached to one axis of said back panel by a hinge.

According to one embodiment, the frame comprises a base and a gripper, comprise matching grooves. The base may be open at its top or at one of its sides and may additionally comprise an advertisement space.

According to another embodiment, the frame comprises slits at its top and a flat panel, spanning the frame's length, said panel attached to two levers moving along vertical slits, said slits positioned on both side panels of the frame.

### BRIEF DESCRIPTION OF THE DRAWINGS

The various objects, advantages and novel features of the present invention will be more fully apparent from a reading of the following detailed description, when read in conjunction with the accompanying drawings, in which like reference numerals refer to like parts and in which:

FIG. 1 schematically illustrates the various parts of the invention;

FIG. 2 schematically illustrates the fixed panel;

FIGS. 3A and 3B schematically illustrates the grooves on the base and on the gripper, respectively;

FIG. 4 schematically illustrates the different-lengths pins;

FIG. 5 schematically illustrates the angled positioning of the license plate holder, according to the present invention;

FIG. 6 schematically illustrates another embodiment of the present invention; and FIGS. 7A to 7C schematically illustrates three alternative embodiments of the present invention.

### DETAILED DESCRIPTION OF A PREFERRED EMBODIMENT

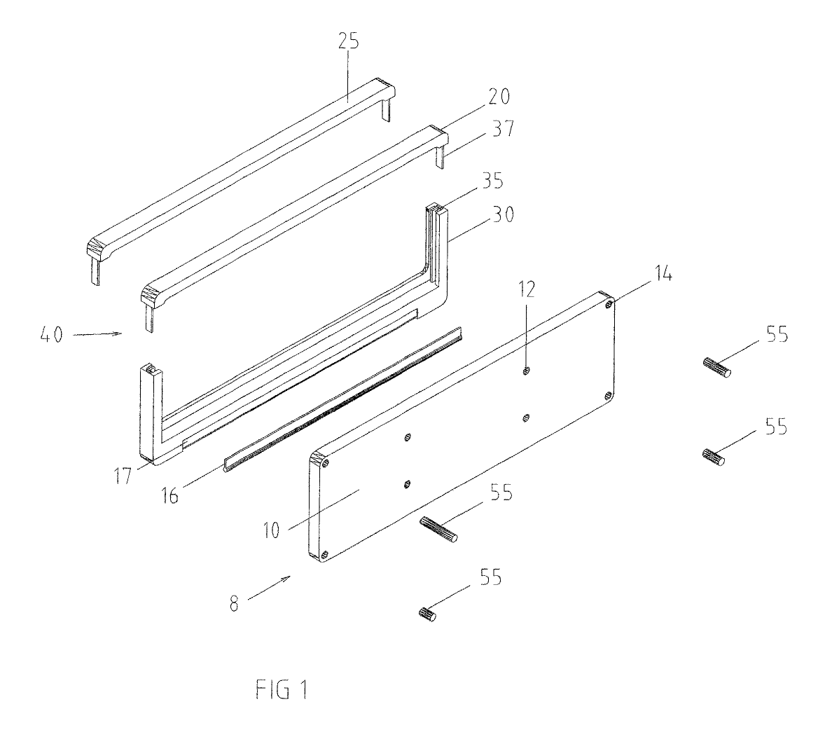

Attention is drawn to FIG. 1, which schematically shows the various parts of the license plate holder of the present invention.

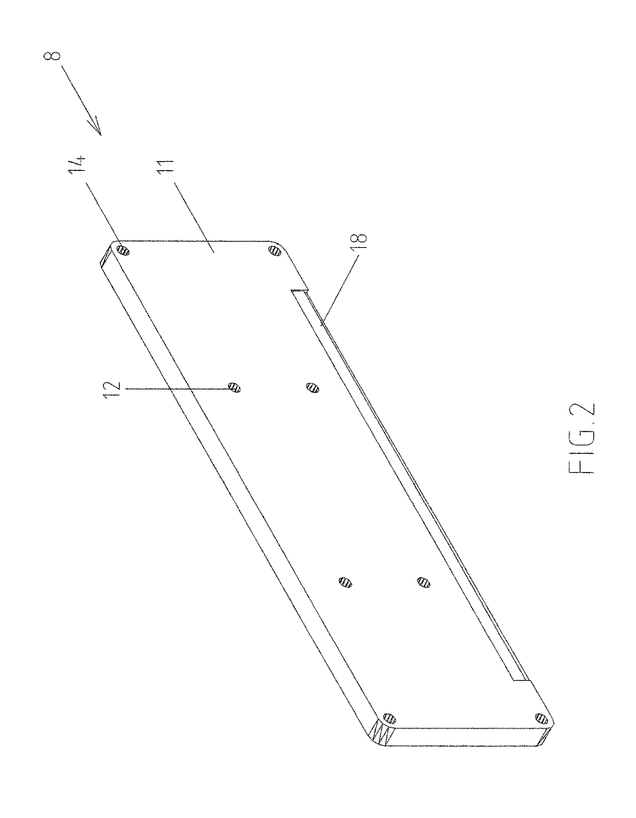

A rectangular panel 8 is attached to the appropriate license-plate location (not shown) at the front and/or rear of a vehicle. Surface 10 of panel 8 is the surface adjacent to the vehicle. Panel 8 comprises a plurality of attachment-drills 12, for attaching the panel 8 to the vehicle with screws, or any other means used for attaching license plates, when no angling of the license plate is desired. Panel 8 additionally comprises angling drills 14. Hinge 16 is attached to panel 8 along its bottom longitudinal side, fitting into groove 18 on the surface 11 (FIG. 2), opposite to surface 10. For clarity, hinge 16 is drawn separately in FIG. 1.

Frame 40 comprises base 30 and gripper 20. Base 30 has, along its bottom longitudinal side, groove 17 which, when accommodating hinge 16, attached on its other side to groove 18, form a means to move the upper part of frame 40 away from panel 8 in the manner of opening a book.

Alternatively, hinge 16 may be attached along any other side of panel 8, whereas grooves 17 and 18 will be formed on the equivalent sides of base 30 and panel 8, respectively .

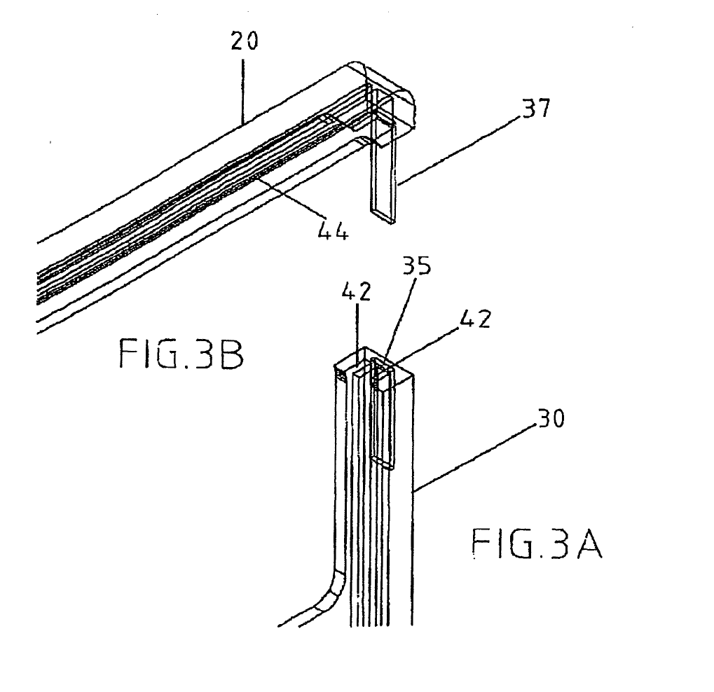

Base 30 additionally comprises grooves 35, adapted to accommodate protrusions 37 of gripper 20. An additional gripper 25 may be provided to replace gripper 20 when gripper 20 has been removed, as will be explained in details in conjunction with FIGS. 3A and 3B to which attention is now drawn.

FIG. 3A illustrates in detail one side-panel of base 30 of frame 40. In addition to grooves 35, adapted to accommodate protrusions 37 of gripper 20, the side-panel comprises grooves 42, of differing widths and number. Grooves 42 are adapted to accommodate at least one license plate and a license plate cover.

Gripper 20, illustrated in detail in FIG. 3B, comprises grooves 44, the number and widths of which match the number and widths of grooves 42.

Alternatively, base 30 may only open on one of its sides, in which case grooves 35 and 42 of base 30 are formed along the inner side of the bottom and top longitudinal sides of base 30 and the length of grippers 20 and 25 matches the height of base 30.

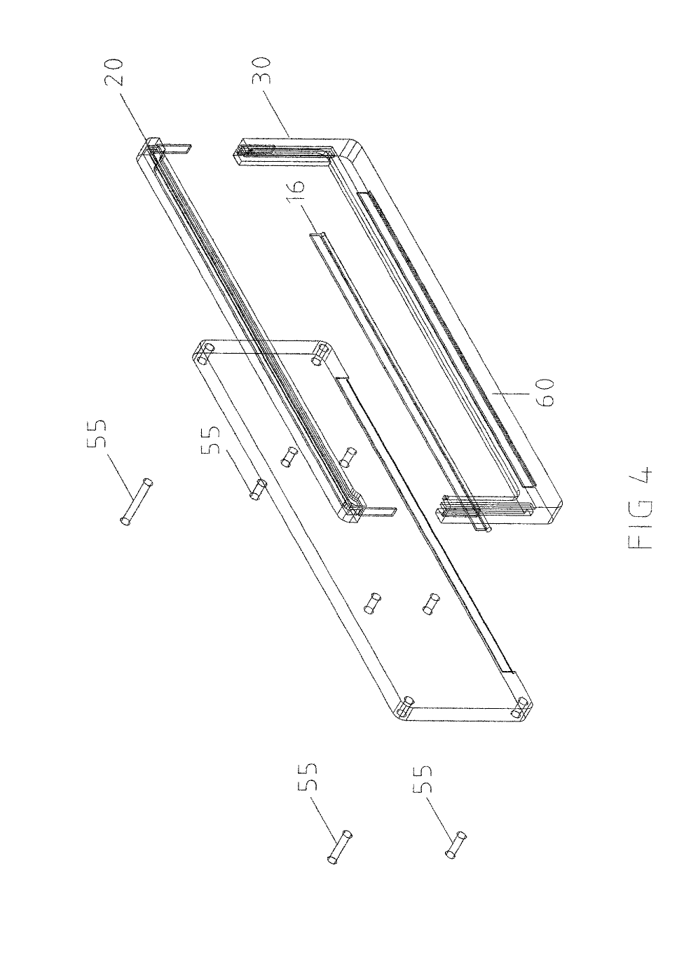

Attention is drawn now to FIG. 4, where hollow pins 55 of differing lengths are shown. These differing lengths serve to form an angle between panel 8 and the vehicle. The angle may be horizontal, vertical, or a combination of both, depending on the placement and lengths of pins 55. For example, if a vertical angle is desired, the two upper pins will be equal sized and longer than the two lower pins, which will also be equal sized. Upper and lower pins may change roles for an opposite vertical angle. If a horizontal angle is desired, the two right pins will be equal sized and longer than the two left pins, which will also be equal sized. Right and left pins may change roles for an opposite horizontal angle. If a horizontal and verical angle is desired, two of the diagonal pins will have different lengths, while the remaining two diagonal pins may be of equal or different length, to create the desired angle.

The license plate holder is attached to the vehicle by passing screws through the pins and screwing them to the vehicle.

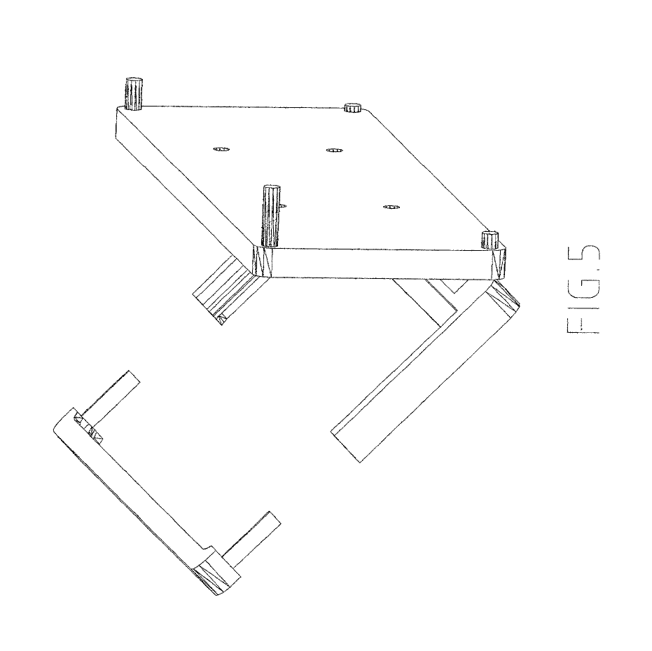

Attention is drawn now to FIG. 5, in which the license plate holder of the present invention is illustrated, with four pins 55 of different lengths. Pins 55 lengths are adapted to enable angling of the frame to any desired angle between 0° and 180°, horizontally and/or vertically.

Turning back to FIG. 4, base 30 may additionally comprise, on any one of its side panels, area 60 for advertisement, messages, or any other text or graphics.

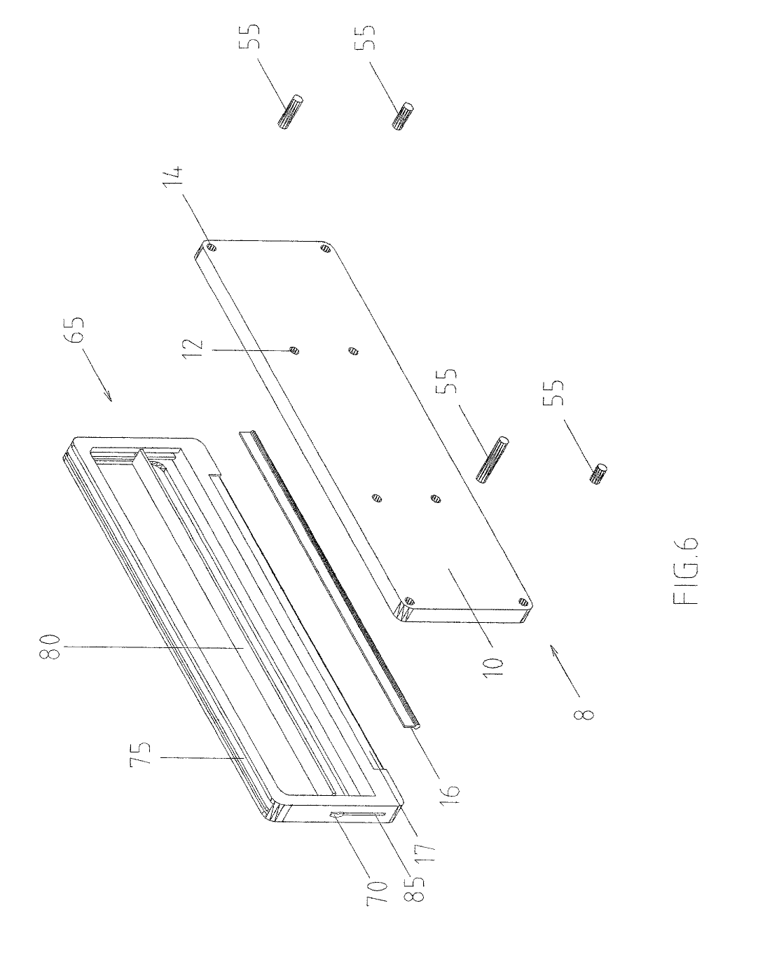

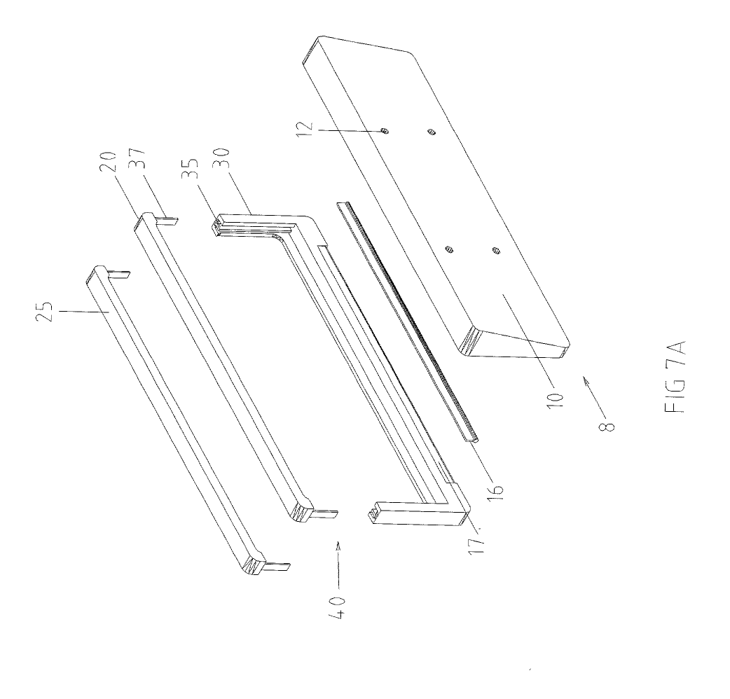

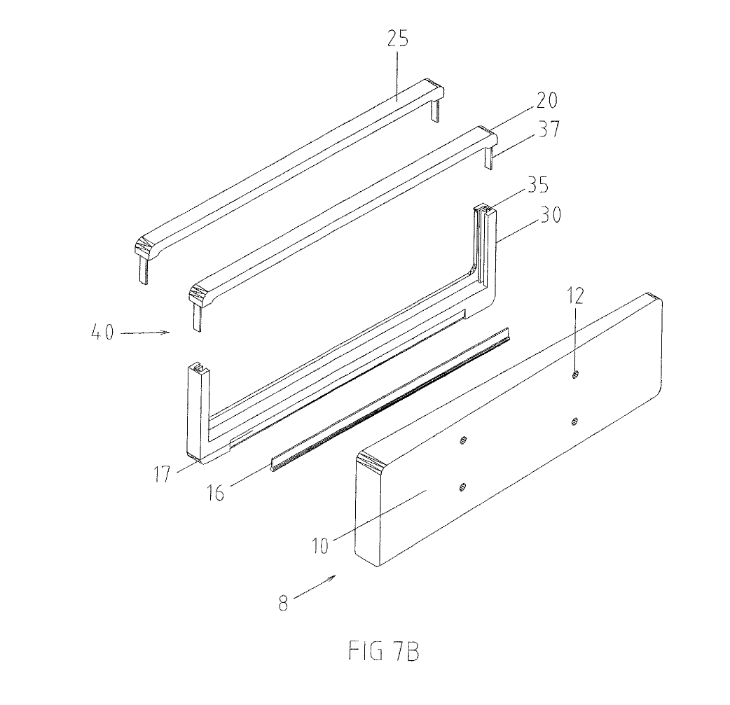

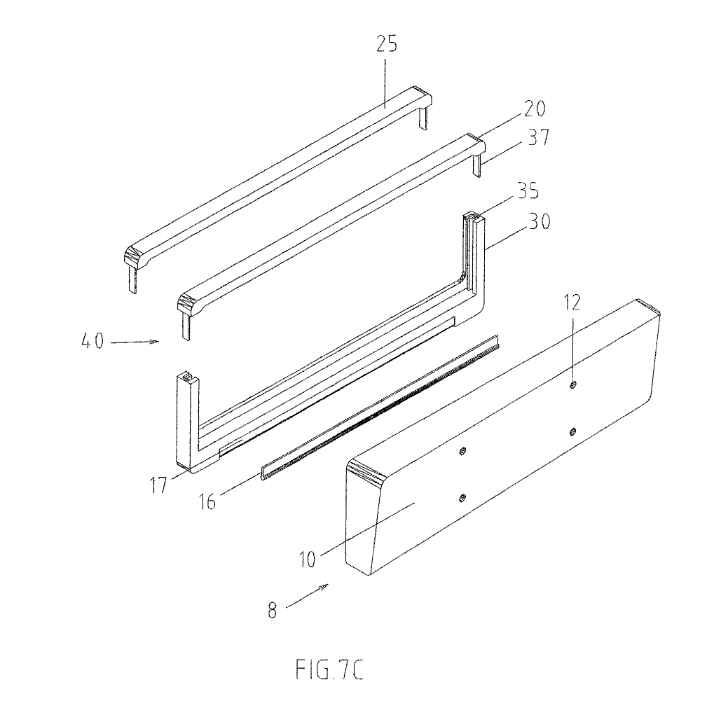

Attention is drawn now to FIG. 6, schematically illustrating another embodiment of the present invention. In this embodiment, the frame 65 consists of one part, unlike frame 40 of FIG. 1. Flat panel 80, attached on both sides to levers 70, spans the length of frame 65. Levers 70 move along slits 85, formed on both side panels of frame 65. Levers 70 and slits 85 may be installed on the outer sides of frame 65, as depicted in FIG. 6, or on the back side of frame 65, hidden in FIG. 6.

The one or more license plates and the license plate cover are inserted through the slits 75 in the upper side of the frame, until they rest on panel 80. Levers 70 are then pushed down along slits 85, to their lowermost position. At this position the license plate(s) and the license plate cover are totally inserted into the frame 65. In order to remove the license plate(s) and the license plate cover, levers 70 are pushed upwards along slits 85, causing panel 80 to push the plates and cover through slits 75.

When the desired angle for installing the license plate holder has been established, the appropriate sizes and arrangement of the pins is chosen. For example, if the desired angle is 13° vertical and the holder's height is X, the difference in size between the two short pins and the two long pins is 0.42X.

Attention is drawn now to FIGS. 7A to 7C, schematically illustrating three variations of another embodiment of the present invention. In this embodiment, panel 8 does not have the regular shape of panel 8 in FIG. 1. The pins 55 are absent and the required fixed angle is formed by the shape of panel 8. In FIG. 7A, panel 8 creates a vertical angle, having its upper panel thicker than its bottom panel, or vice versa, and the two side panels of identical thickness. In FIG. 7B, panel 8 creates a horizontal angle, having one of its side panels thicker than the other and the top and bottom panels of identical thickness. In FIG. 7C, panel 8 forms an angle that is combined of a horizontal and a vertical shift, by having four different panels.

When panel 8, connected to base 30, has been attached to the vehicle, the license plate is inserted into one of the grooves 42. The licensed plate is covered with a micro-prismatic lens cover, which is inserted into another groove 42. When both license plate and cover have been inserted, gripper 20 is applied to base 30 by inserting protrusions 37 into grooves 35. The license plate and the cover are gripped by grooves 44 of gripper 20.

When leaving the vehicle, the driver may pull out gripper 20, along with the license plate and/or the cover. Gripper 25 may serve to close the frame 40 at such times and it may or may not comprise grooves.

Some vehicles have different license plates for use in different states. In such a case, frame 40 may comprise an additional groove, to accommodate the additional license plate.

It will be appreciated by persons skilled in the art that the present invention is not limited by what has been particularly shown and described herein above. Rather the scope of the invention is defined by the claims that follow.

I claim:

1. A license plate holder comprising:
A rectangular back panel attached to the vehicle, said back panel comprising a plurality of angling drills;
a frame, attached to one axis of said back panel by a hinge; and
pins of differing lengths, adapted to be inserted into said plurality of angling drills.

2. The license plate holder of claim 1, wherein said frame comprises a base and a gripper.

3. The license plate holder of claim 2, wherein said base and said gripper comprise matching grooves.

4. The license plate holder of claim 2, wherein said base is open at its top.

5. The license plate holder of claim 2, wherein said base is open at its side.

6. The license plate holder of claim 1, additionally comprising advertisement space.

7. The license plate holder of claim 1, wherein said frame comprises slits at its top and wherein said frame additionally comprises a flat panel, spanning said frame's length, said panel attached to two levers moving along vertical slits, said slits positioned on both side panels of said frame.

8. A method for diffusing the flashlight of a vehicle-detection camera at different angles, comprising the steps of:
providing a rectangular license plate holder having a fixed part and a movable part, wherein said movable part is attached to said fixed part along one of said fixed part's sides;
attaching said fixed part to the vehicle by a plurality of pins of differing lengths, forming an angle between said fixed part and said vehicle;
inserting a license plate and a license plate cover comprising a micro-prismatic lens into said movable part.

9. The method of claim 8, wherein said movable part comprises a base and a gripper.

10. The method of claim 9, wherein said base comprises grooves, adapted to accommodate at least said license plate and said cover.

11. The method of claim 10, wherein said gripper comprises grooves, said gripper grooves matching said base grooves, said gripper grooves adapted to grip at least said license plate and said cover.

12. The method of claim 8, wherein said movable part comprises slits at its top and wherein said movable part additionally comprises a flat panel, spanning said movable part's length, said panel attached to two levers moving along vertical slits, said slits positioned on both side panels of said movable part.

13. The method of claim 8, wherein said movable part additionally comprises an advertisement space.

14. A method for removing a license plate, comprising the steps of:
providing a license plate holder comprising a fixed part and a movable part, wherein said movable part is attached to said fixed part along one of its sides with a hinge and wherein said movable part comprises a base and a gripper, said base comprising grooves adapted to accommodate at least one license plate and said gripper comprising matching grooves adapted to grip said at least one license plate; and
pulling said at least one license plate out of said holder by removing said gripper.

15. The method of claim 14, wherein said base grooves and said gripper grooves are adapted to additionally accommodate a license plate cover and wherein said step of pulling additionally comprises pulling said license plate cover.

16. The method of claim 14, additionally comprising, after said step of pulling, the step of covering said base with a second gripper.

17. The method of claim 16, wherein said second gripper comprises grooves.

18. A method for removing a license plate, comprising the steps of:
providing a license plate holder comprising a fixed part and a movable part, wherein said movable part comprises grooves adapted to accommodate at least one license plate and wherein said movable part additionally comprises slits at its top and a flat panel, spanning said movable part's length, said panel attached to two levers moving along vertical slits, said slits positioned on both side panels of said movable part; and
pulling said at least one license plate out of said holder by sliding said levers along said slits in an upward direction.

19. A license plate holder for a vehicle comprising:
an angled back-panel attached to the vehicle; and
a frame, attached to one axis of said back panel by a hinge.

20. The license plate holder of claim 19, wherein said frame comprises a base and a gripper.

21. The license plate holder of claim 19, wherein said base and said gripper comprise matching grooves.

22. The license plate holder of claim 20, wherein said base is open at its top.

23. The license plate holder of claim 20, wherein said base is open at its side.

24. The license plate holder of claim 19, additionally comprising advertisement space.

25. The license plate holder of claim 19, wherein said frame comprises slits at its top and wherein said frame additionally comprises a flat panel, spanning said frame's length, said panel attached to two levers moving along vertical slits, said slits positioned on both side panels of said frame.

26. The license plate holder of claim 19, wherein at least two sides of said back-panel have unequal thickness, thereby creating said angle.
